(19) United States
(12) Patent Application Publication
(10) Pub. No.: US 2015/0186943 A1
(43) Pub. Date: Jul. 2, 2015

(54) ADVERTISEMENT SCHEME

(71) Applicant: KT Corporation, Seongnam-si (KR)

(72) Inventors: Young-sam CHUN, Seoul (KR); Jinhee JEONG, Seoul (KR); Yeong-il SEO, Seoul (KR)

(21) Appl. No.: 14/582,435

(22) Filed: Dec. 24, 2014

(30) Foreign Application Priority Data
Dec. 30, 2013 (KR) 10-2013-0167528

(51) Int. Cl. G06Q 30/02; H04N 21/2668; H04N 21/258; H04N 21/81

(52) U.S. Cl. CPC G06Q 30/0261; H04N 21/812; H04N 21/2668; H04N 21/25841; G06Q 30/0267

(57) ABSTRACT

In one example embodiment, a method to provide an advertisement stream includes: identifying a first slot in a content stream that is to be transmitted to a device; selecting a first advertisement to be transmitted to the device based on a context of at least one of the identified first slot, the content stream, and location information of the device; determining when the device enters a first geographic zone; and streaming the first advertisement in the first slot in the content stream to the device.

### TECHNICAL FIELD

The embodiments described herein pertain generally to an advertisement scheme.

### BACKGROUND

Location based service (LBS) continues to be exploited to provide advertisements to mobile devices. Limitations to effective advertisements include unreliable location information for respective mobile devices, content limitations imposed by limited screen size for respective mobile devices, and even content filters for respective mobile devices.

### SUMMARY

In one example embodiment, a method to provide an advertisement stream may include: identifying a first slot in a content stream that is to be transmitted to a device; selecting a first advertisement to be transmitted to the device based on a context of at least one of the identified first slot, the content stream, and location information of the device; determining when the device enters a first geographic zone; and streaming the first advertisement in the first slot in the content stream to the device.

In another example embodiment, an advertisement server to provide an advertisement stream may include: an identifier configured to identify a first slot in a content stream that is to be transmitted to a device; an advertisement selector configured to select a first advertisement to be transmitted to the device, based on a context of at least one of the identified first slot, the content stream and location information of the device; a manager configured to determine when the device enters a first geographic zone; and a transmitter configured to stream the first advertisement in the first slot in the content stream to the device.

In yet another example embodiment, a device to play an advertisement stream may include: a memory; and a processing unit configured to transmit location information of the device to an advertisement server, to receive a content stream including a first sub-content segment and a second sub-content segment from a content server, to receive a stream of a first advertisement that is selected based on the location information of the device from the advertisement server, if the device is within a first zone, and to sequentially play the first sub-content segment of the content stream, the stream of the first advertisement and the second sub-content segment of the content stream.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system in which one or more embodiments of an advertisement scheme may be implemented, in accordance with various embodiments described herein;

FIG. 2 shows an example server in which at least portions of an advertisement scheme may be implemented, in accordance with various embodiments described herein;

FIG. 3 shows an example of streaming an advertisement, in accordance with at least portions of various embodiments of an advertisement scheme described herein;

FIG. 4 shows an example of selecting an advertisement, in accordance with at least portions of various embodiments of an advertisement scheme described herein;

FIG. 5 shows an example processing flow by which at least portions of an advertisement scheme may be implemented, in accordance with various embodiments described herein;

FIG. 6 shows an example device in which at least portions of an advertisement scheme may be implemented, in accordance with various embodiments described herein; and

FIG. 7 shows another example processing flow by which at least portions of an advertisement scheme may be implemented, in accordance with various embodiments described herein.

FIG. 8 shows an illustrative computing embodiment, in which any of the processes and sub-processes of an advertisement scheme may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

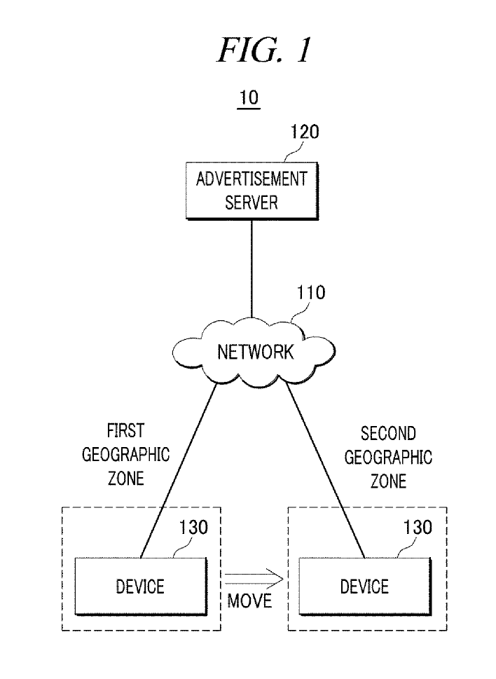

FIG. 1 shows an example system 10 in which one or more embodiments of an advertisement scheme may be implemented, in accordance with various embodiments described herein. As depicted in FIG. 1, system configuration 10 may include, at least, an advertisement server 120, and a device 130. Advertisement server 120 and device 130 may be communicatively connected to each other via a network 110. Device 130 may move through geographic zones. Geographic zones circumscribed by virtual barrier may refer to geographical boundaries drawn by geo-fencing, which may be an application feature that uses the global positioning system (GPS) or radio frequency identification (RFID) to define geographical boundaries.

For example, programs that incorporate geo-fencing may allow an administrator to set up triggers so when a device enters (or exits) the boundaries defined by the administrator, a text message or email alert is sent. Many geo-fencing applications may incorporate Google Earth, allowing administrators to define boundaries on top of a satellite view of a specific geographical area. Other applications may define boundaries by longitude and latitude or through user-created and Web-based maps.

Network 110 may be a wired or wireless information or telecommunications network. Non-limiting examples of network 110 may include a wired network such as a LAN (Local Area Network), a WAN (Wide Area Network), a VAN (Value Added Network) or the like. Other non-limiting examples of network 110 may include wireless networks such as a mobile radio communication network, including at least one of a 3rd, 4th, or 5th generation mobile telecommunications network (3G), (4G), or (5G); various other mobile telecommunications networks; a satellite network; WiBro (Wireless Broadband Internet); Mobile WiMAX (Worldwide Interoperability for Microwave Access); HSDPA (High Speed Downlink Packet Access) or the like.

“Content stream” may refer to the transmittal of multimedia content from a content providing server to receiving device 130. Upon receiving at least a portion of a content stream, device 130 may begin playing the multimedia content even before the entirety of the content stream has even been transmitted from the content providing server. With regard to a non-limiting example of a content stream, a 2-hour movie or video file may be divided into a plurality of “sub-content segments,” e.g., 24-5 minute video clips. Content-free gaps between consecutive sub-content segments may be referred to as “slots.”

An “advertisement stream” may refer to the transmittal of one or more advertisements from advertisement server 120 to one or more of receiving devices 130. An advertisement may be multimedia content that is received by and presented on device 130. With regard to a non-limiting example of an advertisement stream, a multimedia advertisement stream may be divided into a plurality of advertisement segments, e.g., 5 second advertisement segments that may fill one or more of the slots corresponding to the multimedia content stream.

Advertisement server 120 may refer to a server or other computing device that may be configured or operable to provide an advertisement stream to one or more of receiving devices 130. In some embodiments, advertisement server 120 may divide a content stream into a first sub-content segment and a second sub-content segment prior to transmitting the content stream to device 130. The content stream may include video and/or audio content, e.g., movies, sports events, concerts, etc.

Advertisement server 120 may also identify a slot between the ending point of the first sub-content segment and the starting point of the second sub-content segment, based on a predefined content segment table recording the ending point and the starting point of each sub-content segment.

Advertisement server 120 may be configured to, after identifying the first slot in the content stream, select a first advertisement segment to be transmitted to one or more of devices 130 based on a context of the identified first slot, including location information of the device, advertisement priority, etc.

In some embodiments, with respect to advertisement priority, advertisement server 120 may store a plurality of advertisements and metadata corresponding to each of the plurality of advertisements in a database 270. Further, the information of each of the plurality of advertisements may include at least one of an advertiser and a length of the advertisement. With regard to the plurality of advertisements, the priority to be selected as the first advertisement filling in the first slot may be determined in accordance with an advertiser's rank in the amount paid by the advertiser and a length of the advertisement.

As an example, in connection with particular video content, i.e., a movie, it may be assumed that McDonalds® has paid the highest advertisement fees compared to other advertisers. As a result, because McDonalds® has made the highest investment with regard to the particular video content, then McDonalds® advertisements may be granted the top priority for advertisements inserted into slots of the particular video content transmitted to end device 130.

In some embodiments, to effectively manage, analyze and store the information of the device 130 location and movement, advertisement server 120 may adopt a geo-fence scheme to predetermine a set of boundaries of geographic zones. A geo-fence may be regarded as a dynamically generated boundary that surrounds a store or point of interest. A geo-fence may or may not be symmetrical. It may be established as a range of a communication connection to, e.g., a base station or transponder, located in or near a particular store or point of interest; or a geo-fence may be established by, e.g., geographical features, topographical features, or civic boundaries surrounding a particular store or point of interest.

For example, when device 130 transmits information about the location and movement of device 130 to advertisement server 120, a determination may be made as to whether device 130 is within a geo-fence pertaining to a particular store or point of interest. Location information of the device 130 may include at least one of past movement history of the device 130, a present location of the device 130, and a detected direction of movement of the device 130.

Here, the movement, location, direction of movement may be recorded by GPS positioning system (GPS coordinates), and the history may correspond to accumulated records regarding the movement of the device 130. The past movement history, the present location, and the detected direction of movement of device 130 may be stored in advertisement server 120 exploiting the geo-fence scheme.

A geographical interest zone may be determined by advertisement server 120 based on a geo-fence determination scheme to include at least one advertising zone, wherein the advertising zone may be associated with an area surrounding the Point of Interest (POI). That is, if there is an advertisement medium such as an outdoor billboard within the area surrounding a POI, the advertising zone associated with a POI may correspond to the maximum area in which the user's device 130 may be capable of being exposed to the outdoor billboard. Such maximum area may depend on the outdoor billboard's size or type. To recognize whether the user's device 130 is exposed to the outdoor billboard, advertisement server 120 may detect whether the location of the user device 130 is within communication range of the billboard using near-field communications protocol devices, e.g., Bluetooth®, that may be affixed or proximately located to the billboard.

Further, a configuration of the geographical interest zone may be either square or irregular shape depending on a pattern in which POIs are stored in advertisement server 120. Advertisement server 120 may use the advertising zone to measure how long the user's device 130 has been exposed to the outdoor billboard within the area surrounding POI based on the movement record of device 130 entering the advertising zone stored in advertisement server 120.

Based on predefined geographical interest zones and advertising zones, advertisement server 120 may identify a virtual area that includes at least one of a geographical zone, an advertising zone, or POI, based on a virtual map generated by geo-fence determination scheme that is stored in advertisement server 120. That is, virtual area may be also a geo-fence that may be regarded as dynamically generated boundary that surrounds a store or point of interest. The virtual area may or may not be symmetrical. Further, the virtual area may be established as a range of a communication connection to, e.g., a base station or transponder, located in or near a particular store or point of interest; or a geo-fence may be established by, e.g., geographical features, topographical features, or civic boundaries surrounding a particular store or point of interest.

For example, if device 130 enters a virtual area and remains therein for a certain period of time, then advertisement server 120 may store and analyze the past movement history of the device 130 that includes at least one of an entry time to the virtual area, which may also be referred to as a geo-fenced area, a departure time from the virtual area, an amount of time in which the device 130 remains in the virtual area, a location of the device 130 at a specific time within the virtual area.

For instance, with regard to a device 130 entering a geographical interest zone, advertisement server 120 may infer the time period for which the device 130 had been exposed to advertisement near POI by detecting whether device 130 is located near the billboard using a short-range, e.g., wire replacement, communication technology including but not limited to Bluetooth®, as well as a frequency with which the device 130 has entered a specific geographical interest zone. In addition, advertisement server 120 may store and manage such information, because device 130 continuously transmits its location information to advertisement server 120. Thus, advertisement server 120 may detect direction of movement of the device 130 based on the location information.

Further, based on the above, advertisement server 120 may analyze a detected direction of movement of the device 130 at a specific time. On the basis of the past movement pattern and the present location of the device 130, advertisement server 120 may be configured to select the first advertisement that has been most frequently played to the user's device 130 based on the detected present location.

In some embodiments, with respect to the identified first slot and the content stream, advertisement server 120 may be configured to select the first advertisement segment that fits the identified first slot and the content stream from database 270 storing one or more diverse lengths of advertisements, e.g. from 1 second advertisement to 30 second advertisement. For example, if the identified first slot has a duration of, e.g., 7 seconds and the device is detected as entering a virtual area while playing a hip-hop music, advertisement server 120 may select 7-second-video stream advertising hip-hop clothing.

After advertisement server 120 selects the first advertisement to be transmitted to the device 130 based on a context of at least one of the identified first slot, the content stream, and location information of the device 130, advertisement server 120 may determine when the device 130 enters a first geographic zone based on the predefined map stored in advertisement server 120 and location information of device 130. Advertisement server 120 may then stream the first advertisement in the first slot in the content stream to the device 130. In some embodiments, assuming that advertisement server 120 selects the first advertisement corresponding to the first geographic zone, when the device 130 enters the first geo-fenced zone, advertisement server 120 may stream the first advertisement in the first slot in the content stream to the device 130.

In some embodiments, advertisement server 120 may be configured to anticipate a next geographic zone for the device 130 to enter based on the past movement history of device 130, while the device 130 is located within the first geographic zone. After advertisement server 120 identifies a second slot in the content stream, based on the past movement history, the detected direction of movement of the device 130 and the content stream, advertisement server 120 may select a second advertisement that may be deemed to be appropriate for the anticipated next geographic zone from database 270 storing one or more diverse lengths of advertisements, based on the user's past interest identified on the basis of past movement history such as how long the user device has been exposed to the outdoor billboard in the anticipated next geographic zone.

That is, if the outdoor billboard has previously displayed a specific advertisement so that the user's device has been exposed to the advertisement, advertisement server 120 may record and store the advertisement in database 270, and select the specific advertisement as the second advertisement, while the user's device 130 is located within the first geographic zone. Further, advertisement server 120 may stream the second advertisement to the device 130, before the device 130 enters the anticipated next geographic zone.

In some other embodiments, advertisement server 120 may be configured to identify a second slot in the content stream. In some embodiments, the content stream may be divided into a second sub-content segment and a third sub-content segment. The content stream may include video and/or audio content, e.g., movies, sports events, concerts, etc. Advertisement server 120 may also identify an empty time between the ending point of the second sub-content segment and the starting point of the third sub-content segment, and the empty time may correspond to the second slot. That is, advertisement server 120 may identify, after a sub-content segment is completely played, the waiting time (equivalent to the above empty time) before playing the next sub-content segment. For example, the empty time may last for around 10 seconds, but the amount of empty time may be flexible depending on a content stream, a location of the device 130, user's selection, or the like.

Thus, FIG. 1 shows example system 10 in which one or more embodiments of an advertisement providing scheme may be implemented, in accordance with various embodiments described herein.

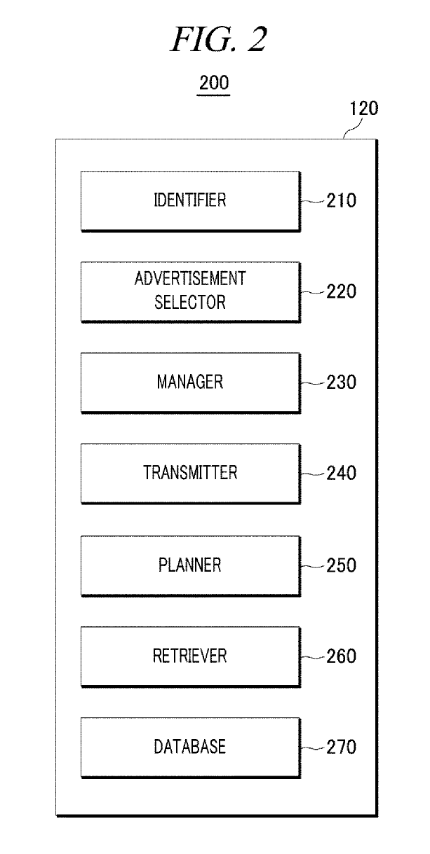

FIG. 2 shows an example server in which at least portions of an advertisement providing scheme may be implemented, in accordance with various embodiments described herein. For example, as depicted in FIG. 2, advertisement server 120 to provide an advertisement stream may include identifier 210 configured to identify a first slot in a content stream that is to be transmitted to a device 130, advertisement selector 220 configured to select a first advertisement to be transmitted to the device 130, based on a context of at least one of the identified first slot, the content stream and location information of the device 130, manager 230 configured to determine when the device 130 enters a first geographic zone, and transmitter 240 configured to stream the first advertisement in the first slot in the content stream to the device 130.

Identifier 210 may be configured to identify a first slot in a content stream that is to be transmitted to a device 130, based on a predefined content segment table recording the ending point and the starting point of each sub-content segment. The content stream to be transmitted to the device 130 may be divided into a first sub-content segment and a second sub-content segment.

For example, in case of music streaming, the first sub-content segment may correspond to a hip-hop music, while the second sub-content segment may correspond to a classic song. A non-limiting example of the content stream may include video and/or audio content stream of movie, drama, sport events, music and the like.

Identifier 210 may also identify an empty time between the ending point of the first sub-content segment and the starting point of the second sub-content segment based on a predefined content segment table recording the ending point and the starting point of each sub-content segment, and such empty time may correspond to the first slot.

Advertisement selector 220 may be configured to select a first advertisement segment to be transmitted to the device 130, based on a context of at least one of the identified first slot, the content stream and location information of the device 130. For example, advertisement selector 220 may select the first advertisement, based on the identified first slot and location information of the device 130, among a database storing a plurality of advertisements and advertisement segments of various lengths.

As an example of an advertisement selection, if it may be assumed that the identified first slot corresponds to 10 seconds and the device 130 is expected to enter a first geographic zone based on the past movement history of the device 130, a present location of the device 130, and a detected direction of movement of the device 130. If the first geographic zone includes a POI having an outdoor billboard for, e.g., “Nike®,” advertisement selector 220 may select a 10-second-advertisement or advertisement segment for Nike® clothing or shoes as the first advertisement.

As another example of an advertisement selection, advertisement selector 220 may select the first advertisement, based on the content stream and location information of the device 130. If it may be assumed that the device 130 is playing a free dance music video and the device 130 is expected to enter a first geographic zone based on the past movement history of the device 130, a present location of the device 130, and a detected direction of movement of the device 130 and if the device 130 playing a free dance music video is presently located in front of a convenience store and tends to move toward north direction, the first geographic zone may correspond to an advertising zone or a geographical interest zone located north of the convenience store. Further, any advertisement related to dance music (e.g. running shoes, music album, or singer's accessory) may be selected as the first advertisement.

As still another example of an advertisement selection, advertisement selector 220 may select the first advertisement or advertisement segment, based on the identified first slot and the content stream. If the identified first slot is, e.g., 7 seconds and the device 130 is playing a live broadcast of a baseball game, advertisement selector 220 may select 7-second-advertisement or advertisement segment for, e.g., Yankees® apparel or season tickets as the first advertisement.

Manager 230 may be configured to determine when the device 130 enters a first geographic zone, and transmitter 240 may be configured to stream the first advertisement in the first slot in the content stream to the device 130. Because device 130 and advertisement server 120 are connected via network 110, manager 230 may receive location information of device 130 in GPS coordinates, and based on the location information, manager may determine when device 130 enters a first geographic zone (e.g. 14:02). Once manager 230 determines the time of entering the first geographic zone, transmitter 240 may stream the selected first advertisement to device 130.

Planner 250 may be configured to anticipate an upcoming geographic zone in which device 130 will enter while the device 130 is located within the first geographic zone. Because advertisement server 120 may store the analyzed past history of movement of device 130, planner may anticipate the next geographic zone for device 130 to enter. At this point, advertisement selector 220 may be further configured to select, in advance, a second advertisement to be transmitted to device 130. The second advertisement may be selected based on a context of at least one of the identified first slot, the content stream, and location information of device 130.

After advertisement selector 220 selects the second advertisement, transmitter 240 may be further configured to stream the second advertisement to device 130, before device 130 enters the anticipated next geographic zone. By virtue of such scheme, even though if device 130 abruptly terminates playing a content stream and restarts it, and if an identified slot or an empty time may become unstable, transmitter 240 may stream, to device 130, appropriate advertisement within area in which device 130 is located.

Retriever 260 may be configured to retrieve metadata of the first advertisement. The metadata may include the first advertisement's advertiser, promotion duration, media attribute such as a video or an audio file. For example, if the first advertisement corresponds to Toyota® USA, the metadata may include Toyota® USA, 6 months, video stream. After retriever 260 retrieves metadata of the first advertisement, transmitter 240 may be further configured to transmit the metadata to device 130.

Advertisement selector 220 may be further configured to store a plurality of advertisements and advertisement segments, as well as information for each of the plurality of the advertisements and advertisement segments in a database 410. Further, the information of each of the plurality of advertisements may include at least one of an advertiser, a length of the advertisement, and a media attribute, while the media attribute may include video or audio stream. With regard to the plurality of advertisements, the priority to be selected as the first advertisement filling in the first slot may be determined in accordance with an advertiser's rank in the amount paid by the advertiser and a length of the advertisement.

For example, suppose that Samsung® paid the most amount of advertisement fees for a month (e.g. 1 million) than any other advertiser but the duration of promotion only lasts for two months. On the contrary, suppose that Apple paid smaller amount of advertisement fees than Samsung® (e.g. 0.5 million) but the duration of promotion lasts for 6 months In terms of total investment in advertisement, Apple® ranks higher than Samsung®, and thus Apple® may be granted the top priority to be selected as the first advertisement.

Thus, FIG. 2 shows an example server in which one or more embodiments of an advertisement providing scheme may be implemented, in accordance with various embodiments described herein.

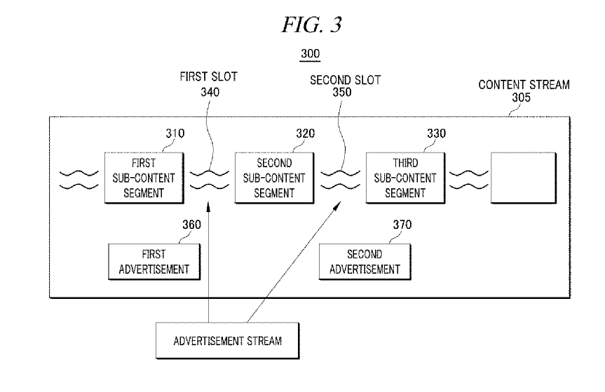

FIG. 3 shows an example of streaming advertisement in accordance with at least portions of various embodiments of an advertisement scheme described herein. FIG. 3 depicts a content stream and advertisement in the slot, when device 130 moves from a first geographic zone to a second geographic zone. The content stream 305 may be divided into first sub-content segment 310, second sub-content segment 320, and third sub-content segment 330. The content stream 305 may include first slot 340 between first sub-content segment 310 and second sub-content segment 320, and second slot 350 between second sub-content segment 320 and third sub-content segment 330.

In some embodiments, device 130 may moves to a first geographic zone and be located in an advertising zone included in the first geographic zone. At this point, advertisement server 120 may select first advertisement 360 to be transmitted to device 130 based on a context of at least one of the identified first slot, the content stream, and location information of device 130. After that, advertisement server 120 may stream first advertisement 360 in the first slot 340 to device 130 after determining when device 130 enters a first geographic zone.

While device 130 remains in the first geographic zone, advertisement server 120 may anticipate a second geographic zone for device 130 to enter after the first geographic zone, based on past movement history. In this case, advertisement server 130 may identify a second slot 350 in the content stream 305, select a second advertisement 370 based on a context of at least one of the identified second slot, the content stream, and location information of the device 130. Then, if determining when device 130 enters the second geographic zone, advertisement server 120 may stream the second advertisement 370 in the second slot 350 in the content stream 305 to the device 130.

Thus, FIG. 3 shows an example of streaming advertisement in accordance with at least portions of various embodiments of an advertisement scheme described herein.

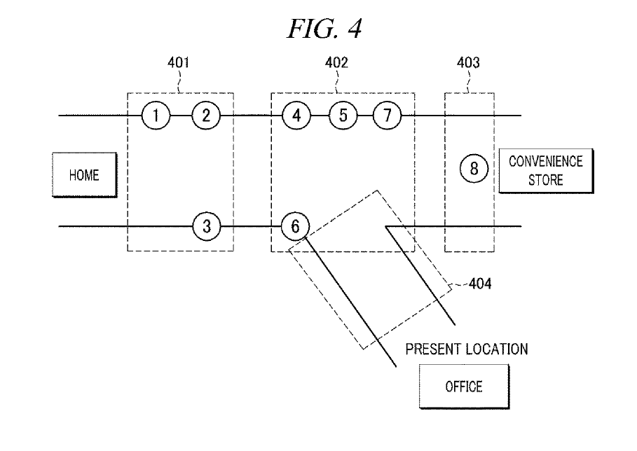

FIG. 4 shows an example of selecting an advertisement, in accordance with at least portions of various embodiments of an advertisement scheme described herein. In the non-limiting example of FIG. 4, it may be assumed that a device 130 is playing a free music streaming while moving from home to convenience store. It may be further assumed that the device 130 remains at the office, and there may be four geographic zones in the movement path, such as a first geographic zone 401, a second geographic zone 402, a third geographic zone 403, and a fourth geographic zone 404 between home and convenience store.

Advertisement server 120 may collect the movement information such as an entry time to a geographic zone, a departure time from the geographic zone, an amount of time in which the device is present in the geographic zone, a location of the device at a specific time, and weather conditions when the device 130 is present in the geographic zone. Further, based on such information, advertisement server 120 may infer the device 130 movement pattern and select advertisements to be transmitted to device 130 while device 130 is present in a specific geographic zone.

In some embodiments, when device 130 departed from home, is present at the office, and is anticipated to visit convenience store, advertisement server 120 may determine that number 6, 7, 5, and 4 advertisement is to be transmitted to device 130, while device 130 is present in the second geographic zone, and that number 8 advertisement is to be transmitted to device 130 while device 130 is present in the third geographic zone. Further, while number 6 advertisement is being transmitted to device 130, advertisement server 120 may notify in advance information of the next advertisement to device 130, by transmitting number 7 advertisement to device 130.

Thus, FIG. 4 shows an example of selecting an advertisement, in accordance with at least portions of various embodiments of an advertisement scheme described herein.

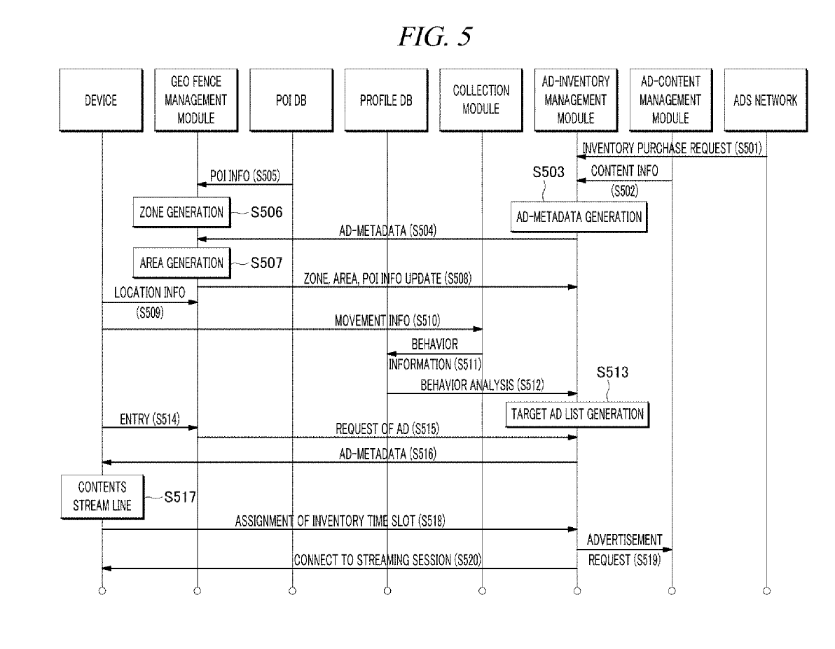

FIG. 5 shows an example processing flow by which at least portions of an advertisement providing scheme may be implemented, in accordance with various embodiments described herein. “Advertisement” may be referred to as an “Ad.” In FIG. 5, ad-inventory management module in advertisement server 120 may receive a purchase request of ad-inventory through ads network (S501), and receive content info from ad-content management module in advertisement server 120 (S502). Ad-inventory management module may generate ad-metadata of advertisement (S503), and transmit, to geo fence management module in advertisement server 120, the ad-metadata of advertisement (S504). Geo-fence may be referred to as interest domain.

POI DB including information of POIs may transmit, to geo fence management module, information of POIs (S505). Further, geo fence management module may generate a zone representing interest domain based on the information of POIs (S506), and may generate area representing advertisement domain based on ad-metadata received from ad-inventory module (S507). Geo fence management module may update information by transmitting, to ad-inventory management module, the information of the generated zone, area and POIs (S508).

Afterwards, geo fence management module may collect location information of device 130 from device 130 (S509), and may collect movement information of device 130 through collection module in advertisement server 120 (S510). Collection module may transmit, to profile DB, behavior information including device movement (S511), and ad-inventory management module may generate a list of target advertisement for device 130 (S513) based on the behavior analysis information stored in profile DB (S512).

Once device 130 enters the generated interest domain (S514), geo-fence management module may request advertisement or advertisement segment in ad-inventory management module (S515), and ad-inventory management module may transmit in advance, to device 130, metadata of advertisement that is expected to be transmitted to device 130 (S516).

Afterwards, while a content stream is being played on device 130 (S517), ad-inventory management module may identify empty time and assign time slot (S518), and may request, to ad-content management module, advertisement or advertisement segment (S519). Ad-content management module may connect to a session to transmit advertisement stream including advertisement segment, for empty time between sub-content segments, or assigned time slot (S520), and may transmit, to device 130, advertisement stream.

Thus, FIG. 5 shows an example processing flow by which at least portions of an advertisement providing scheme may be implemented, in accordance with various embodiments described herein.

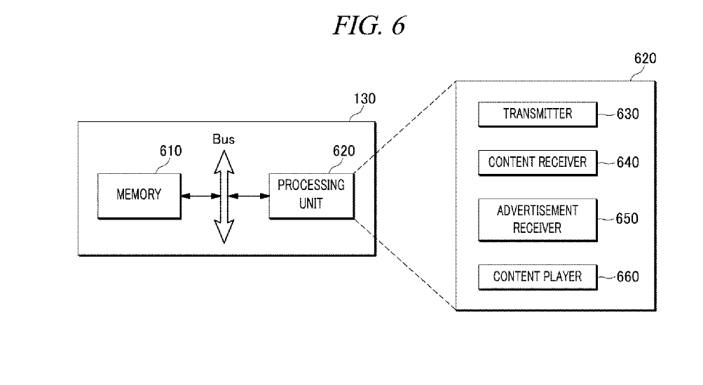

FIG. 6 shows an example device in which at least portions of an advertisement providing scheme may be implemented, in accordance with various embodiments described herein. Device 130 for playing an advertisement stream may include a memory 610, and a processing unit 620. Processing unit 620 may further include a transmitter 630 to transmit location information of device 130 to an advertisement server 120, a content receiver 640 to receive a content stream including a first sub-content segment and a second sub-content segment from a content server, an advertisement receiver 650 to receive a stream of a first advertisement that is selected based on the location information of the device 130 from the advertisement server 120, if the device 130 is within a first zone, and a content player 660 to sequentially play the first sub-content segment of the content stream, the stream of the first advertisement and the second sub-content segment of the content stream.

Memory 610 may be configured to store a plurality of advertisements and/or a plurality of metadata for the plurality of advertisements received from advertisement server 120. Further, memory 610 may refer to, e.g., a volatile memory, non-volatile memory, or any combination thereof. In some embodiments, when advertisement server 120 transmits, to device 130, metadata of a specific advertisement, memory 610 may search for the corresponding advertisement to the received metadata among the stored plurality of advertisements and transmit the corresponding advertisement to processing unit 620.

Transmitter 630 may be configured to transmit location information of the device 130 to an advertisement server 120. In some embodiments, the location information may include an address in GPS coordinates determined by the Global Positioning System (GPS) that is a space-based satellite navigation system that provides location and time information in all weather conditions. In addition, the location information may include information of whether device 130 is located in a virtual area including at least one of a geographical interest zone, an advertising zone, or a POI (Point of Interest).

Content receiver 640 may be configured to receive a content stream including a first sub-content segment and a second sub-content segment from a content server. In some embodiments, the content stream may include free music video, free movie, free sport channel, etc. The first sub-content segment may be sequentially arranged before the second sub-content segment.

Advertisement receiver 650 may be configured to receive a stream of a first advertisement that is selected based on the location information of the device 130 from the advertisement server 120, if the device 130 is within a first geographic zone. In some embodiments, the first advertisement may correspond to an advertisement that has been most frequently played to the device 130 within the first geographic zone, in consideration of past movement history of device 130 and detected direction of device 130 based on the location information of the device 130.

Content player 660 may be configured to sequentially play the first sub-content segment of the content stream, the stream of the first advertisement, and the second sub-content segment of the content stream.

FIG. 6 shows an example device in which one or more embodiments of an advertisement providing scheme may be implemented, in accordance with various embodiments described herein.

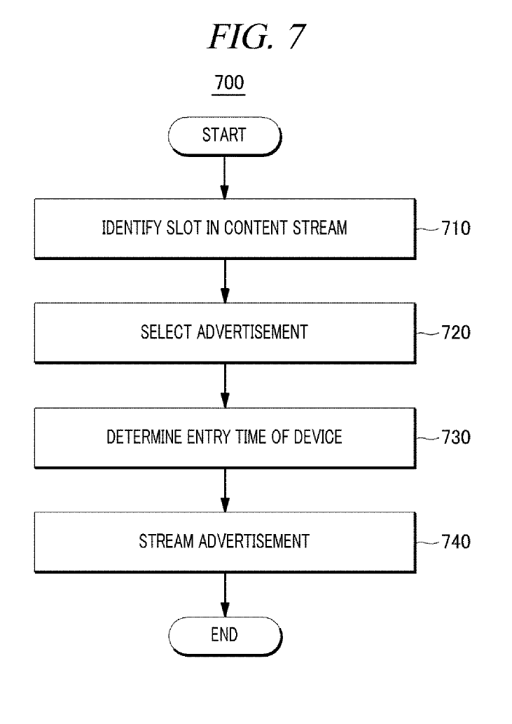

FIG. 7 shows another example processing flow by which at least portions of an advertisement providing scheme may be implemented, in accordance with various embodiments described herein. The operations of processing flow 700 may be implemented in system configuration 10 including network 110, advertisement server 120, and device 130, as illustrated in FIG. 1. Processing flow 700 may include one or more operations, actions, or functions as illustrated by one or more blocks 710, 720, 730, and/or 740. Although illustrated as discrete blocks, various blocks may be divided into additional blocks, combined into fewer blocks, or eliminated, depending on the desired implementation. Processing may begin at block 710.

Block 710 (identify slot in content stream) may refer to advertisement server 120 identifying a first slot in a content stream that is to be transmitted to device 130. A content stream to be transmitted to the device 130 may be divided into a first sub-content segment and a second sub-content segment. The content stream may include video and/or audio content stream of movie, drama, sport, music and the like.

Advertisement server 120 may also identify an empty time between the ending point of the first sub-content segment and the starting point of the second sub-content segment, and the empty time may correspond to the first slot. That is, advertisement server 120 may identify, after a sub-content segment is completely played, the waiting time (equivalent to the above empty time) before playing the next sub-content segment. For example, the empty time may last for around 10 seconds, but the amount of empty time may be flexible depending on a content stream, a location of the device 130, user's selection, or the like. Processing may proceed from block 710 to block 720.

Block 720 (select advertisement) may refer to advertisement server 120 selecting a first advertisement to be transmitted to device 130 based on a context of at least one of the identified first slot, the content stream, and location information of device 130. In some embodiments, with regard to device 130 entering a geographical interest zone, advertisement server 120 may infer the time period for which the device 130 had been exposed to advertisement in POI and a frequency with which the device 130 entered a specific geographical interest zone.

In addition, advertisement server 120 may store and manage such information, based on which advertisement server 120 may analyze a detected direction of movement of the device 130 at a specific time. On the basis of the past movement pattern and the present location of the device 130, advertisement server 120 may select the first advertisement that has been most frequently played to the device 130 at the present location among the plurality of advertisements. Processing may proceed from block 720 to block 730.

Block 730 (determine entry time of device) may refer to advertisement server 120 determining when the device 130 enters a first geographic zone. Processing may proceed from block 730 to block 740.

Block 740 (streaming advertisement) may refer to advertisement server 120 streaming the first advertisement in the first slot in the content stream to device 130.

Thus, FIG. 7 shows another example processing flow by which at least portions of an advertisement providing scheme may be implemented, in accordance with various embodiments described herein.

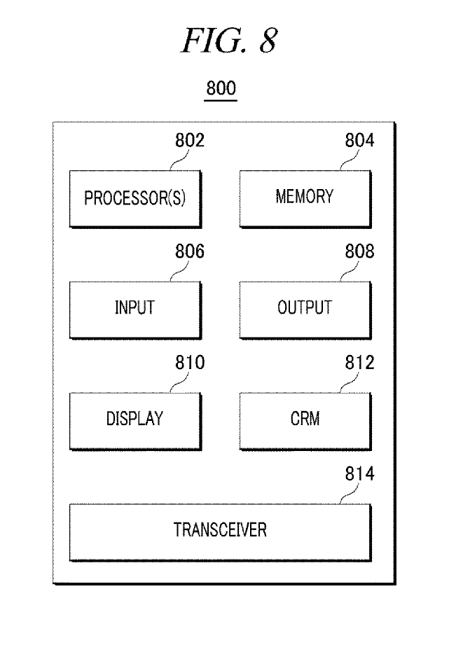

FIG. 8 shows an illustrative computing embodiment, in which any of the processes and sub-processes of a content sharing scheme may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 800 may typically include, at least, one or more processors 802, a system memory 804, one or more input components 806, one or more output components 808, a display component 810, a computer-readable medium 812, and a transceiver 814.

Processor 802 may refer to, e.g., a microprocessor, a microcontroller, a digital signal processor, or any combination thereof.

Memory 804 may refer to, e.g., a volatile memory, non-volatile memory, or any combination thereof. Memory 804 may store, therein, an operating system, an application, and/or program data. That is, memory 804 may store executable instructions to implement any of the functions or operations described above and, therefore, memory 804 may be regarded as a computer-readable medium.

Input component 806 may refer to a built-in or communicatively coupled keyboard, touch screen, or telecommunication device. Alternatively, input component 806 may include a microphone that is configured, in cooperation with a voice-recognition program that may be stored in memory 804, to receive voice commands from a user of computing device 800. Further, input component 806, if not built-in to computing device 800, may be communicatively coupled thereto via short-range communication protocols including, but not limitation, radio frequency or Bluetooth.

Output component 808 may refer to a component or module, built-in or removable from computing device 800, which is configured to output commands and data to an external device.

Display component 810 may refer to, e.g., a solid state display that may have touch input capabilities. That is, display component 810 may include capabilities that may be shared with or replace those of input component 806.

Computer-readable medium 812 may refer to a separable machine readable medium that is configured to store one or more programs that embody any of the functions or operations described above. That is, computer-readable medium 812, which may be received into or otherwise connected to a drive component of computing device 800, may store executable instructions to implement any of the functions or operations described above. These instructions may be complimentary or otherwise independent of those stored by memory 804.

Transceiver 814 may refer to a network communication link for computing device 800, configured as a wired network or direct-wired connection. Alternatively, transceiver 814 may be configured as a wireless connection, e.g., radio frequency (RE), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

Thus, FIG. 8 shows an illustrative computing embodiment, in which any of the processes and sub-processes of a content sharing scheme may be implemented as computer-readable instructions stored on a computer-readable medium, in accordance with various embodiments described herein.

We claim:

1. A method to provide an advertisement stream, comprising:
identifying a first slot in a content stream that is to be transmitted to a device;
selecting a first advertisement to be transmitted to the device based on a context of at least one of the identified first slot, the content stream, and location information of the device;
determining when the device enters a first geographic zone; and
streaming the first advertisement in the first slot in the content stream to the device.

2. The method of claim 1, further comprising:
identifying a second slot in the content stream;
selecting a second advertisement to be transmitted to the device, based on a context of at least one of the identified second slot, the content stream, and location information of the device;
determining when the device enters a second geographic zone; and
streaming the second advertisement in the second slot in the content stream to the device.

3. The method of claim 1, further comprising:
anticipating a next geographic zone for the device to enter while the device is located within the first geographic zone;
selecting a second advertisement to be transmitted to the device; and
streaming the second advertisement to the device before the device enters the anticipated next geographic zone.

4. The method of claim 3, further comprising:
identifying a second slot in the content stream,
wherein the selecting is based on a context of at least one of the identified second slot and the content stream.

5. The method of claim 1, further comprising:
retrieving metadata of the first advertisement; and
transmitting the metadata to the device.

6. The method of claim 1, wherein the selecting comprises storing a plurality of advertisements and information of each of the plurality of advertisements in a database,
wherein the information includes at least one of an advertiser, a promotion duration, and a media attribute.

7. The method of claim 1, wherein the selecting is further based on an advertisement priority that is based on at least one of an advertiser's rank in the amount paid by the advertiser and a promotion duration.

8. The method of claim 1, wherein the first geographic zone corresponds to one of a geographical interest zone, an advertising zone, or a POI (Point of Interest).

9. The method of claim 8, wherein the geographical interest zone is determined based on a geo-fence determination scheme to include at least one advertising zone, and
wherein the advertising zone is associated with an area surrounding the POI.

10. The method of claim 1, wherein the location information of the device includes at least one of past movement history of the device, a present location of the device, and a detected direction of movement of the device.

11. The method of claim 10, wherein the past movement history includes at least one of an entry time to a virtual area, a departure time from the virtual area, an amount of time in which the device is present in the virtual area, a location of the device at a specific time, and weather conditions when the device is present in the virtual area, and
wherein the virtual area includes at least one of a geographical interest zone, an advertising zone, or a POI (Point of Interest).

12. An advertisement server to provide an advertisement stream, comprising:
an identifier configured to identify a first slot in a content stream that is to be transmitted to a device;
an advertisement selector configured to select a first advertisement to be transmitted to the device, based on a context of at least one of the identified first slot, the content stream and location information of the device;
a manager configured to determine when the device enters a first geographic zone; and
a transmitter configured to stream the first advertisement in the first slot in the content stream to the device.

13. The advertisement server of claim 12, further comprising:
a planner configured to anticipate a next zone for the device to enter while the device is located within the first zone,
wherein the advertisement selector is further configured to select a second advertisement to be transmitted to the device, and
wherein the transmitter is further configured to stream the second advertisement to the device before the device enters the anticipated next geographic zone.

14. The advertisement server of claim 12, further comprising:
a retriever configured to retrieve metadata of the first advertisement,
wherein the transmitter is further configured to transmit the metadata to the device.

15. The advertisement server of claim 12, wherein the advertisement selector is further configured to store a plurality of advertisements and information of each of the plurality of advertisements in a database,
wherein the information includes at least one of an advertiser, a promotion duration, and a media attribute.

16. The advertisement server of claim 12, wherein the location information of the device includes at least one of past movement history of the device, a present location of the device, and a detected direction of movement of the device.

17. The advertisement server of claim 12, wherein the advertisement selector is further configured to select the first advertisement further based on an advertisement priority that is based on at least one of an advertiser's rank in the amount paid by the advertiser and a promotion duration.

18. The advertisement server of claim 12, wherein the first geographic zone corresponds to one of a geographical interest zone, an advertising zone, or a POI (Point of Interest).

19. The advertisement server of claim 18, wherein the geographical interest zone is determined based on a geo-fence determination scheme to include at least one advertising zone, and
wherein the advertising zone is associated with an area surrounding the POI.

20. A device to play an advertisement stream, comprising:
a memory; and
a processing unit configured to:
transmit location information of the device to an advertisement server;
receive a content stream including a first sub-content segment and a second sub-content segment from a content server;
receive a stream of a first advertisement that is selected based on the location information of the device from the advertisement server, if the device is within a first geographic zone; and
sequentially play the first sub-content segment of the content stream, the stream of the first advertisement and the second sub-content segment of the content stream.
